(19) United States
(12) Patent Application Publication
(10) Pub. No.: US 2011/0173056 A1
(43) Pub. Date: Jul. 14, 2011

(54) COMPUTERIZED SYSTEMS AND PROCESSES FOR PROMOTING BUSINESSES

(76) Inventors: Dennis D'Alessio, Newport Beach, CA (US); Richard D'Alessio, Newport Beach, CA (US); Ray Mario Renzi, Ladera Ranch, CA (US)

(21) Appl. No.: 12/836,481

(22) Filed: Jul. 14, 2010

Related U.S. Application Data
(60) Provisional application No. 61/225,534, filed on Jul. 14, 2009.

(51) Int. Cl. G06Q 30/00

(52) U.S. Cl. 705/14.16

(57) ABSTRACT

Embodiments of the invention include systems and methods for helping businesses increase word of mouth marketing/advertising and manage relationships with their customers. Embodiments are also directed to helping businesses quantify the effect of the generated word of mouth marketing/advertising. Certain embodiments provide incentives for customers to write online reviews of the businesses they patronize. Customers can also refer businesses to a review, profile and marketing management system through which the businesses can purchase additional marketing services, which may include providing the referred businesses: (1) access to a review module to respond to customer reviews posted to the system, (2) the ability to provide special offers to customers who have signed up with the system to generate additional reviews, and (3) content data posted on the system (e.g. web viewable content) in which basic information of the businesses is integrated with the reviews. In one embodiment, the content data is optimized to achieve high search engine rankings.

### CROSS-REFERENCE TO RELATED APPLICATIONS

This application claims the benefit of priority from U.S. Provisional Patent Application No. 61/225,534 filed on Jul. 14, 2009, entitled “Systems and Methods for Managing and Improving Business to Customer Relationships,” the disclosure of which is hereby incorporated by reference. All publications and patent applications mentioned in this specification are herein incorporated by reference in their entirety to the same extent as if each individual publication or patent application was specifically and individually indicated to be incorporated by reference.

### BACKGROUND

1. Field

This disclosure relates in general to computer data processing, and in particular to computer based systems and processes for promoting businesses.

2. Description of the Related Art

Businesses often advertise to attract new customers through traditional channels of marketing such as print, media, and online marketing. Word of mouth marketing/advertising is based on referrals given by a business' existing customers to new customers, and is usually considered a more effective form of marketing than marketing through the aforementioned traditional channels. However, many businesses, especially small businesses, do not have a systematic way to generate such marketing/advertising due to lack of resources. Although some word of mouth marketing/advertising have migrated to the online environment in the form of review sites and social networking sites, businesses typically have little control over the contents of those sites and have limited means to motivate loyal and/or satisfied customers to provide positive reviews of the businesses.

### SUMMARY OF THE DISCLOSURE

Embodiments of the invention include systems and methods for helping businesses increase word of mouth marketing/advertising and manage relationships with their customers. Embodiments are also directed to helping businesses quantify the effect of the generated word of mouth marketing/advertising. Certain embodiments described herein provide incentives for customers to write online reviews of the businesses they patronize. Customers can also refer businesses to a review, profile and marketing management system through which the businesses can purchase additional marketing services. The marketing services may include providing the referred businesses: (1) access to a review module to respond to customer reviews posted to the system, (2) the ability to provide special offers to customers who have signed up with the system to generate additional reviews, and (3) content data posted on the system (e.g. web viewable content) in which basic information of the businesses is integrated with the reviews. Other contents such as blogs, press releases, news feeds, images, and contents designed for social networking sites may also be integrated. In one embodiment, the content data is optimized to achieve high search engine rankings.

In one embodiment, customers are incentivized to refer businesses to the system through a reward program by which the customers share a portion of the revenue generated by the marketing packages purchased by referred businesses. In one embodiment, a first person can refer other persons into the system, and the revenue generated by the marketing packages purchased by additional businesses referred by those referred persons is shared with those persons as well as with the first person. In one embodiment, the system maintains data reflecting a hierarchical representation of the order in which persons are referred to the system, and the data is used along with various revenue distribution rules to distribute a portion of the revenue to be shared among various persons in the hierarchy.

### BRIEF DESCRIPTION OF THE DRAWINGS

Specific embodiments of the invention will now be described with reference to the following drawings, which are intended to illustrate embodiments of the invention, but not limit the invention:

FIG. 1 is a flow chart showing the overall system and process in accordance with one embodiment;

FIG. 2 is a system block diagram showing the various components for managing the interaction between member businesses and reviewers;

FIG. 3A is a flow chart showing the revenue sharing method in accordance with one embodiment;

FIG. 3B shows an example of sharing through a sponsor's genealogy;

FIG. 3C shows an example revenue sharing distribution for exclusive promotions;

FIG. 3D shows another example of sharing through a sponsor's genealogy;

FIG. 3E shows another example of revenue sharing for exclusive promotions;

FIG. 4 shows an additional feature to help expand the genealogy in accordance with one embodiment;

FIG. 5 is a flowchart showing a review submission and approval process in one embodiment;

FIG. 6A is a block diagram showing the review, profile and marketing management system as used in one embodiment;

FIG. 6B is a flow chart showing a process performed by the review, profile and marketing management system in accordance with one embodiment;

FIG. 7 is an example user interface for the review, profile and marketing management system in accordance with one embodiment;

FIG. 8 is a flow chart showing a process of optimizing user interfaces that display business information for increased exposure on the Internet and/or other data networking environments in accordance with one embodiment; and

FIG. 9 is a block diagram illustrating the review, profile and marketing management system in accordance with one embodiment

### DETAILED DESCRIPTION OF THE PREFERRED EMBODIMENTS

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

System Architecture and Process—Sponsoring a Business

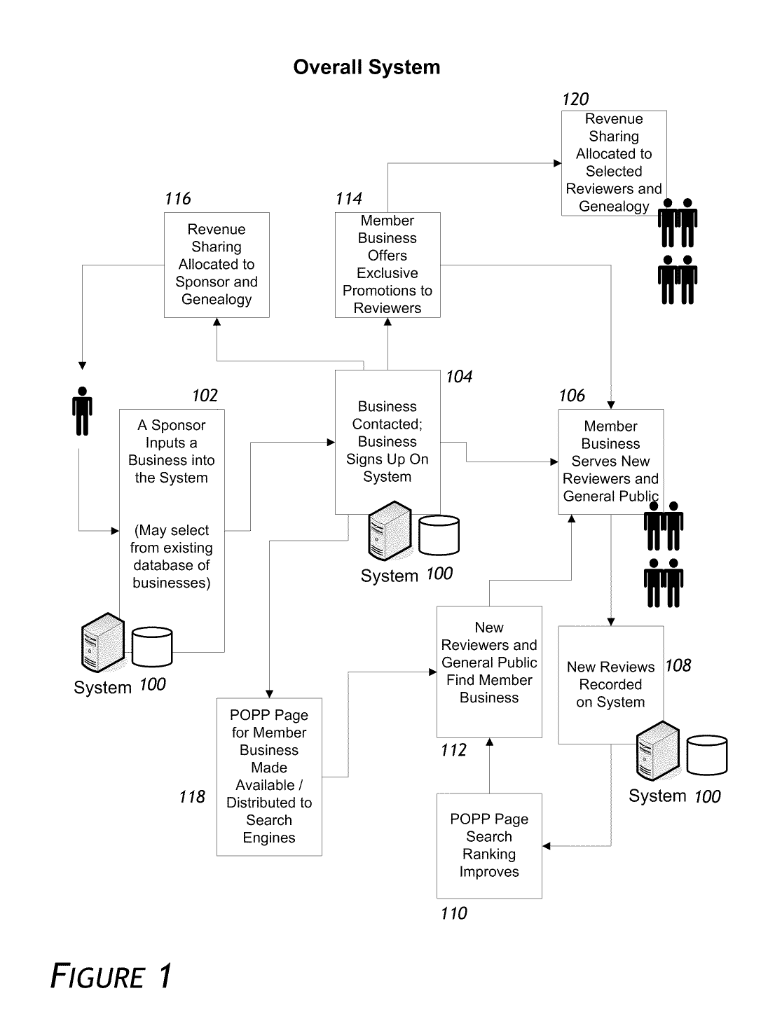

FIG. 1 is a flow chart showing the overall system and process in accordance with one embodiment. At block 102, a sponsor may input information regarding a business into a review, profile and marketing management system 100. In one embodiment, a sponsor is a person who has signed up with the review, profile and marketing management system 100, has met the qualification requirements (where applicable), and has submitted a profile page for a business. Returning to block 102, the sponsor may provide, for the profile page, basic information about the business (e.g., name, address, and phone number) to the review, profile and marketing management system 100. In one embodiment, the sponsor inputs the basic information into the system via a client user interface (not shown). In one embodiment, the qualification requirements to become a sponsor of one or more businesses include paying a sign-up fee. In another embodiment, the person provides information such as contact information (e.g., names, addresses), demographic information, and/or preference information. The sponsor may also choose to sponsor a business that is already listed in one or more databases of businesses associated with the review, profile and marketing management system 100. In one embodiment, the databases may comprise directories of business listings. In one embodiment, once a business is sponsored, its status is changed to a “referred” business in the listings.

At block 104, the business is contacted and is asked to sign up for one or more additional marketing services that are at least partly provided to the business by the review, profile and marketing management system 100. In one embodiment, the review, profile and marketing management system 100 includes a web site interface through which the business can sign up for the aforementioned marketing services. Marketing services may include referral marketing services in which businesses can take advantage of referrals and reviews generated by reviewers interacting with the system. They may also include providing to the business search engine optimization (SEO), blogs, press releases, news feeds, images, and contents designed for social networking sites. The business may be contacted electronically or manually. In one embodiment, a sales agent contacts the business and asks it to purchase a marketing package. For example, a marketing package may include listing a business on a profile page that solicits and/or lists reviews generated through, for example, a referral mechanism. In one embodiment, once the business does so, it becomes a “member” business and is listed as a “certified (superior)” business on content published by the review, profile and marketing management system 100. In addition, the business may become eligible to participate in and/or utilize the various features and components of the review, profile and marketing management system 100 to communicate with its customers and the general public, and utilize the aforementioned marketing services. In other embodiments, a business may purchase various types of marketing packages and may be assigned various designations in addition to or instead of the “superior” and/or “certified (superior)” designations mentioned above. Information related to the businesses in the aforementioned database associated with the review, profile and marketing management system 100 are searchable in one embodiment, and the results provided may be ranked in accordance with a number of criteria. For example, the listing may be ranked so that “certified (superior)” businesses are listed first, followed by “referred” businesses, and then other businesses.

In one embodiment, at block 116, a revenue sharing module allocates to the sponsor (and his/her “genealogy,” as further defined below) a credit for a portion of what the business spends in purchasing and subsequently maintaining the marketing package. As will be discussed further below, in one embodiment, sponsors are organized in a hierarchical multi-level structure. In one embodiment, the hierarchical multi-level structure is termed the “genealogy.” Within the genealogy are reviewers, and certain reviewers are eligible to become sponsors. In one embodiment, reviewers have the ability to invite new reviewers to sign up, and the invited reviewers are allocated under the hierarchical structure (genealogy) of the reviewers who sent the invitations. In one embodiment, the revenue sharing is ongoing, that is, the sponsor and his/her genealogy receive a credit for a portion of what the business spends periodically (e.g., monthly) to remain a member business of the system. The revenue sharing model may enhance the roster of listed businesses in the system both quantitatively and qualitatively. Quantitatively, the revenue sharing motivates the sponsors to increase the number of businesses to sponsor. Qualitatively, since in one embodiment the revenue sharing is on-going, the system motivates the sponsors to carefully select reputable businesses that are likely to benefit from word of mouth marketing and remain a “member” business. In addition, from a data quality perspective, since the sponsors are likely existing customers of the businesses, the contact information provided by the sponsors is likely to be more updated and accurate, and business entries that are outdated may be updated and/or removed.

System Architecture and Process—The Continual Referral Generation Cycle

In one embodiment, the published content includes a Proprietary Pre-Optimized Profile Page (hereinafter “POPP page”), which is data content (e.g. a web page) with built-in attributes that are periodically optimized to ensure higher rankings in search engines and/or other data retrieval tools. In one embodiment, the POPP page includes details about the member business, including contact information, local maps, products and/or services offered, and qualified reviews submitted by reviewers who have patronized the member business. In one embodiment, additional contents such as press releases, blogs, news feeds, and social networking contents maybe included in the POPP pages as well. In one embodiment a POPP page is based on the information in a profile page submitted by a sponsor, and a “certified (superior)” business can change contents of the POPP page for that business. In one embodiment, the POPP page may provide an e-commerce module where the general public can directly purchase products or services from the member business listed. The POPP pages may be located at a directory site, organized by industry verticals with hierarchy, and/or indexed for search. Thus, for example, a visitor to the directory site may be able to enter a search for “boat parts” and see a number of POPP pages of member businesses that offer boat parts and services. Alternatively, the visitor may find the member businesses through accessing a directory with a hierarchical structure or searching for the businesses by name or other criteria. Thus the boat servicers may be accessed, for example, by clicking on a link such as “boats parts and services.”

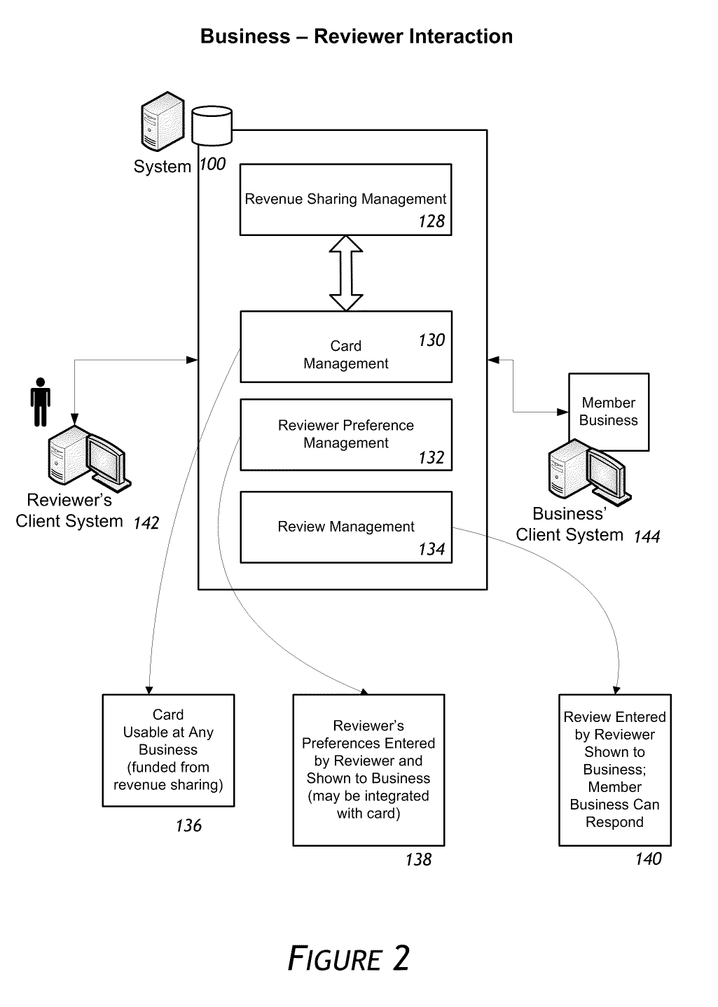

In one embodiment, at block 118, after sign-up, the now member business is listed on a dynamically generated POPP page, which is made available and/or distributed to search engines and/or other data retrieval tools. In one embodiment, the POPP pages are listed on a searchable directory site as mentioned in the previous paragraph. This in turns drives new customers to the member business as the POPP page increases the visibility of the member business on the Internet and/or other networking environments (block 112). At block 106, the business serves new customers from among the general public, who may have found out about the business through content published by the review, profile and marketing management system 100 (e.g., through a search result linking to the POPP page). The new customers may then choose to sign up in the review, profile and marketing management system 100 and provide reviews through a client user interface (not shown), and their reviews of the business are recorded by the review, profile and marketing management system 100 at block 108 in one embodiment. Those who have chosen to sign up are termed “reviewers.” In one embodiment, a “sponsor” and a “reviewer” may be the same person. In one embodiment, reviewers are classified by various levels, and certain reviewers classified in the higher levels are eligible to be sponsors. Additional details regarding reviewers and the sign-up process are provided later in the description of FIGS. 2-4.

In one embodiment, at block 110, as a result of the increased number of reviews on the POPP page for the member business and other search engine ranking optimization features built into the POPP page, the search engine ranking of the POPP page improves. As mentioned above, search engine rankings may be improved simply by virtue of the business being listed on a POPP page because of the built-in optimization (which is periodically updated) in the POPP page. The improvement in search engine ranking may in turn lead to additional reviewers and members of the general public finding the member business at block 112, which may in turn lead back to blocks 106 and 108, where the business may serve these new customers/reviewers and generate additional reviews. In one embodiment, this continual process helps businesses improve and quantify word of mouth marketing and benefit from the ever-increasing exposure. Besides being provided the POPP pages, in one embodiment, the member businesses are also provided analytical/reporting tools to manage the POPP pages and see the number of visitors who have accessed the POPP pages.

System Architecture and Process—Encouraging Additional Reviews Through Exclusive Promotions

Embodiments of the invention provide other means for member businesses to stimulate additional word of mouth marketing. Returning to FIG. 1, once a business becomes a member business, at block 114 the member business may purchase the right to provide exclusive promotions to a number of reviewers, who may be selected based on their geographic locations. In one embodiment, the promotions may also be sent to a marketing list of local potential customers to spur them into signing up with the system to take advantage of the promotions and provide reviews.

In one embodiment, at block 120 a revenue sharing module credits a portion of what the business spends in the purchase to a selected number of reviewers who are first to take advantage of the promotions and complete qualified reviews. The credit may also go to the reviewers' genealogies. For example, in one embodiment, the business may spend $100 to purchase the right to send the exclusive promotions to the geographically targeted reviewers in the system. The promotions may be communicated via emails, text messages, social networking status updates, mailings, and/or other form of printed or electronic communications. The first ten reviewers who write qualified reviews (and optionally with their genealogies), may receive a credit for a portion of the $100 spent by the business. In one embodiment, the costs to provide such exclusive promotions are set to be relatively low as to encourage the member businesses to offer promotions that are very valuable to the reviewers (e.g., steep discount for trying the products or services offered). The high value of the promotions, combined with the time-sensitive nature of the eligibility for revenue sharing, may offer powerful motivation for reviewers to patronize the businesses offering the promotions and write qualified reviews. As discussed above, an increase in the number of reviews may increase a member business' visibility (e.g., by improving search engine rankings) and generate additional new customers for the member business, as well as provide the member business with valuable customer feedback that may be useful in improving goods and/or services offered by the member business.

Reviewer and Business Interaction

In certain embodiments of the systems and methods described herein, the marketing services provided to businesses, e.g., at least partly by the review, profile and marketing management system 100, help the businesses manage relationships with their customers. FIG. 2 is a system block diagram showing the various components for managing the interaction between member businesses and reviewers. In one embodiment, a reviewer can access, via a client system 142, one or more modules of the review, profile and marketing management system 100 that handle the interaction, including a revenue sharing management module 128, a card management module 130, a reviewer preference management module 132, and a review management module 134. Similarly, a member business may access, via a client system 144, one or more of the same modules within the review, profile and marketing management system 100. In one embodiment, the client systems 142 and 144 may be wireless devices. For example, a reviewer may be able to access one or more modules of the review, profile and marketing management system 100 via a mobile phone/mobile device application executed on a mobile phone/mobile device. A reviewer can, for example, write a review on his mobile phone/device while patronizing a business. Similarly, a business may be able to interface with one or more modules of the review, profile and marketing management system 100 with a similar mobile phone/mobile device application.

As discussed above, in one embodiment, certain qualified reviewers are sponsors and are eligible to participate in revenue sharing to receive a portion of the total marketing spending made by the businesses they have sponsored (e.g., monthly marketing spending and exclusive promotions spending). In addition, as also discussed above, certain reviewers may receive revenue sharing credit for submitting qualified reviews in response to the exclusive promotions. Finally, as discussed further below, revenue sharing is distributed upward through the genealogy, so a reviewer may receive a portion of the revenue generated by reviewers/sponsors downline from his or her genealogy. In one embodiment, the revenue sharing management module 118 keeps track of the credits that are allocated to the reviewers in the system. As will be discussed further below, in one embodiment, reviewers are organized in a hierarchical multi-level structure termed the “genealogy.” In one embodiment, as explained further below, revenue sharing is distributed also through the genealogies for the qualified sponsors and reviewers.

In one embodiment, the revenue sharing management module 128 is linked to the card management module 130, which supports a payment card a reviewer can use for making purchases or some other card that can provide additional features to the reviewer as described below. In one embodiment, as shown in block 136, the card may be a debit card that is generally acceptable by businesses that accept debit cards. Thus, a reviewer may use his/her assigned card to spend credit allocated to him or her through the revenue sharing processes disclosed herein. In other embodiments, instead of or in addition to payment cards, payments based on revenue sharing may be made via checks and/or other forms of electronic payment methods such as Paypal or electronic fund transfer such as that offered by the Automated Clearing House (ACH).

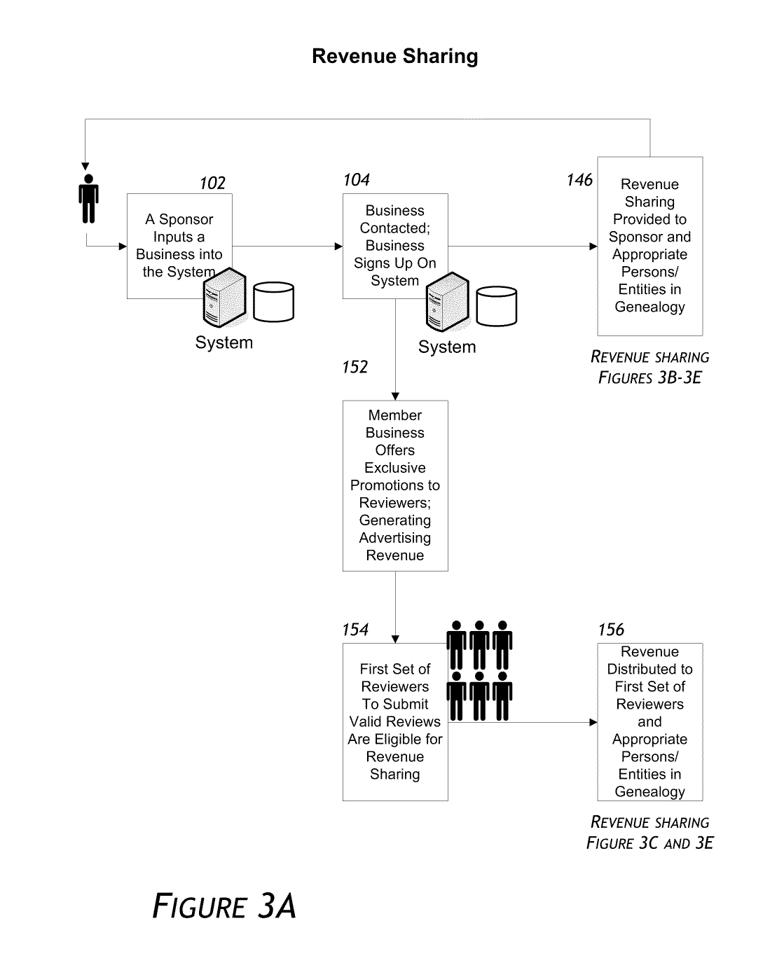

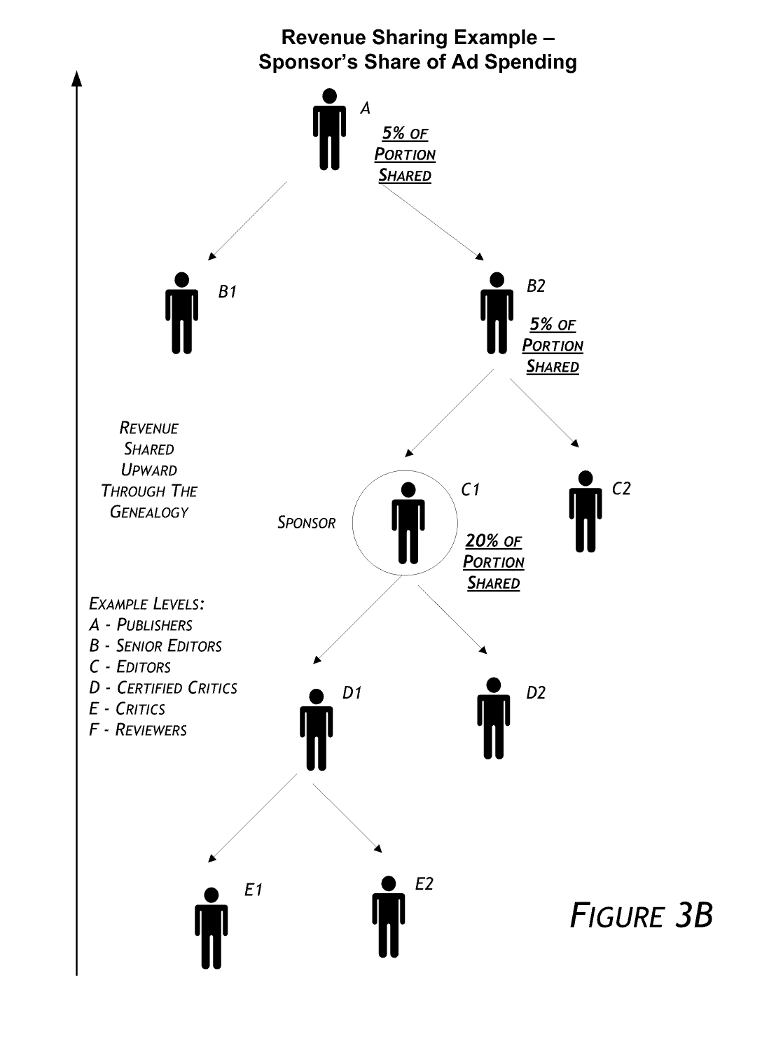

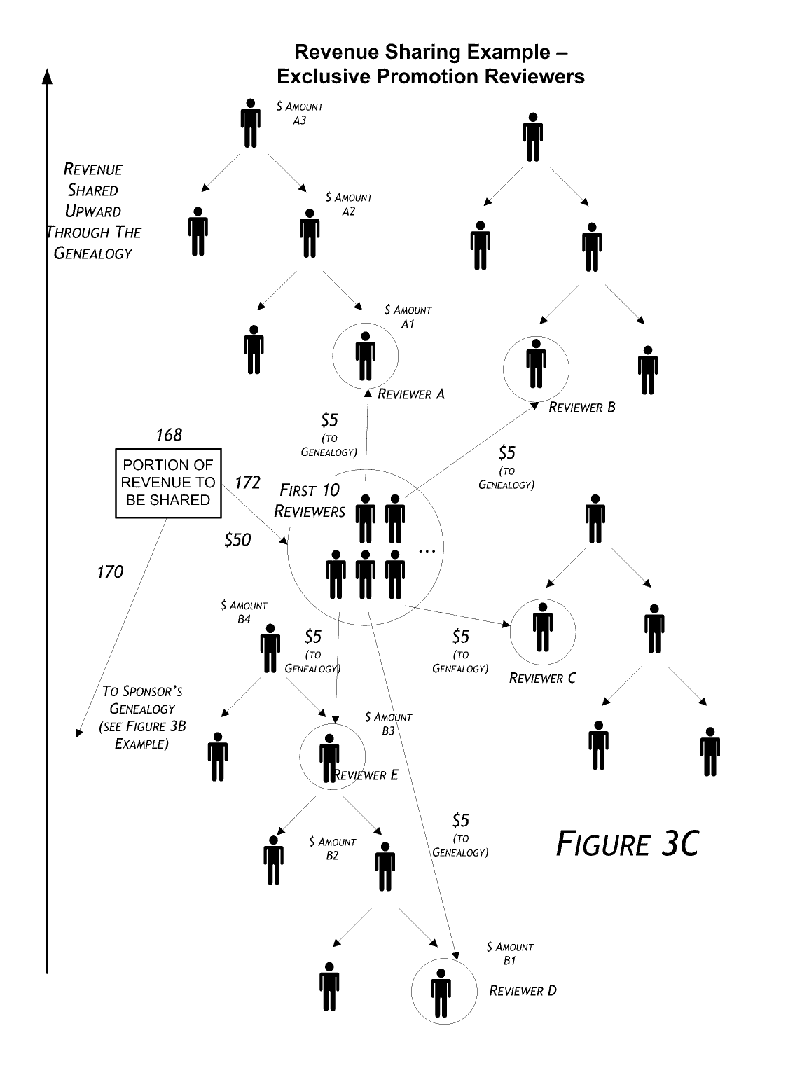

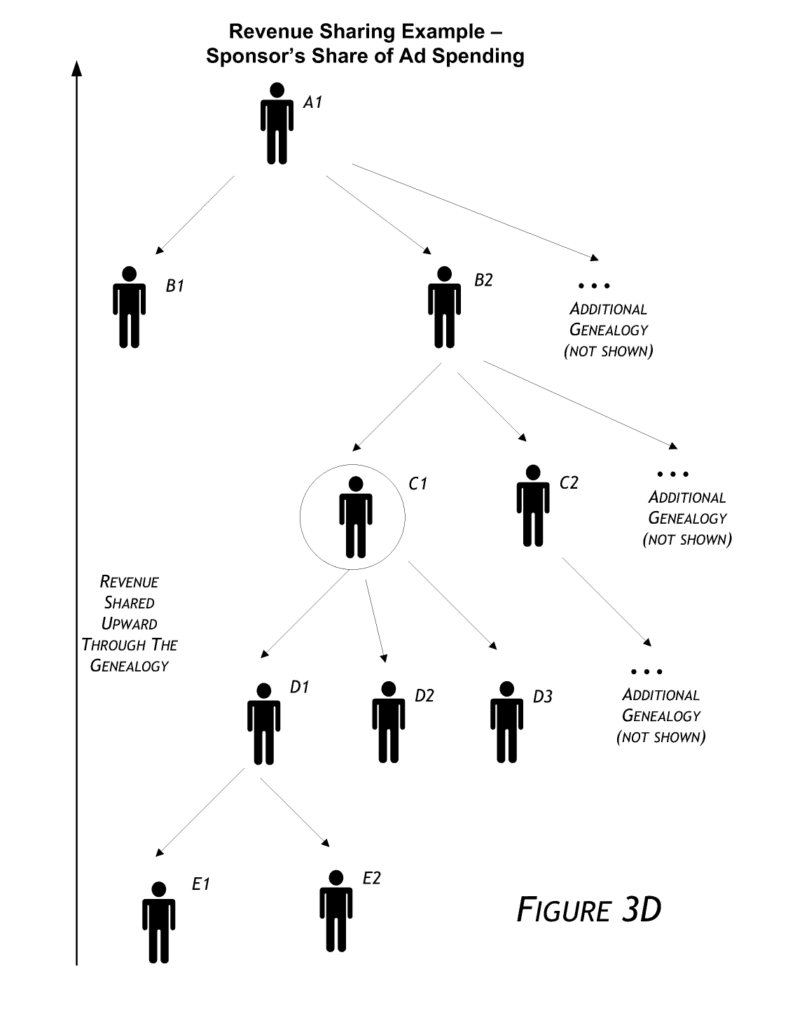

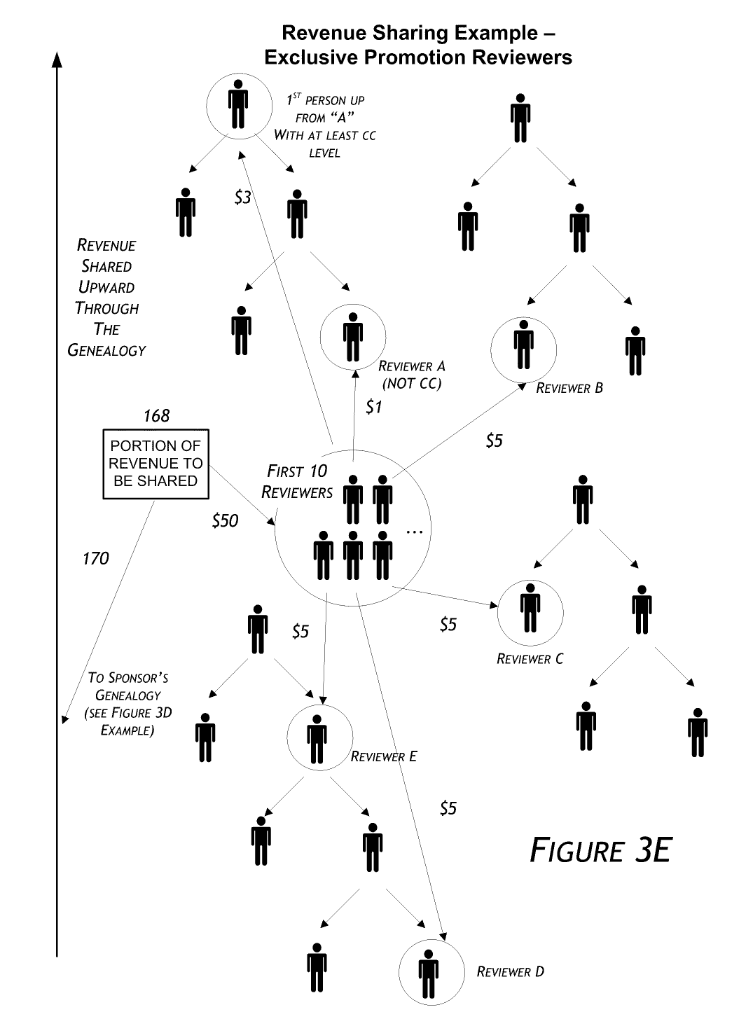

In one embodiment, the card management module 130 is also linked to the reviewer's preference management module 132, which stores the reviewer's preferences into the payment and/or other card. The reviewer's preference management module 132 may also makes the reviewer's preferences available to a business that receives reviewer identification information of the reviewer from the payment and/or other card and queries the review, profile and marketing management system 100 with the reviewer identification information. The preferences may be edited and/or entered by the reviewers via the client system 142. For example, a reviewer may enter a number of dining preferences through the client system 142 into the reviewer preference management module 132. As shown in block 138, the dining preferences (e.g., preferred table location, preferred menu items, etc.) may then be stored into the payment and/or other card or made accessible via an identification code stored on the payment and/or other card. In one embodiment, the preferences are business-specific or category-specific (e.g., preferences for dinning at restaurants, preferences for shopping at clothing stores). In one embodiment, the preferences are stored into the payment and/or other card so they can be retrieved by member businesses. Mechanisms for the storage/retrieval of reviewer preferences may include radio frequency identification (RFID), smart chip, magnetic strip, etc. In one or more embodiments, the level assigned to the reviewer may also be stored in the payment or other card, printed on the card, or otherwise made accessible by the card. For example, the business may be able to discern from the card that the reviewer is a high-level reviewer who may wield a greater influence. An example listing of the various levels of reviewers is shown in FIGS. 3B and 3D and further described below.

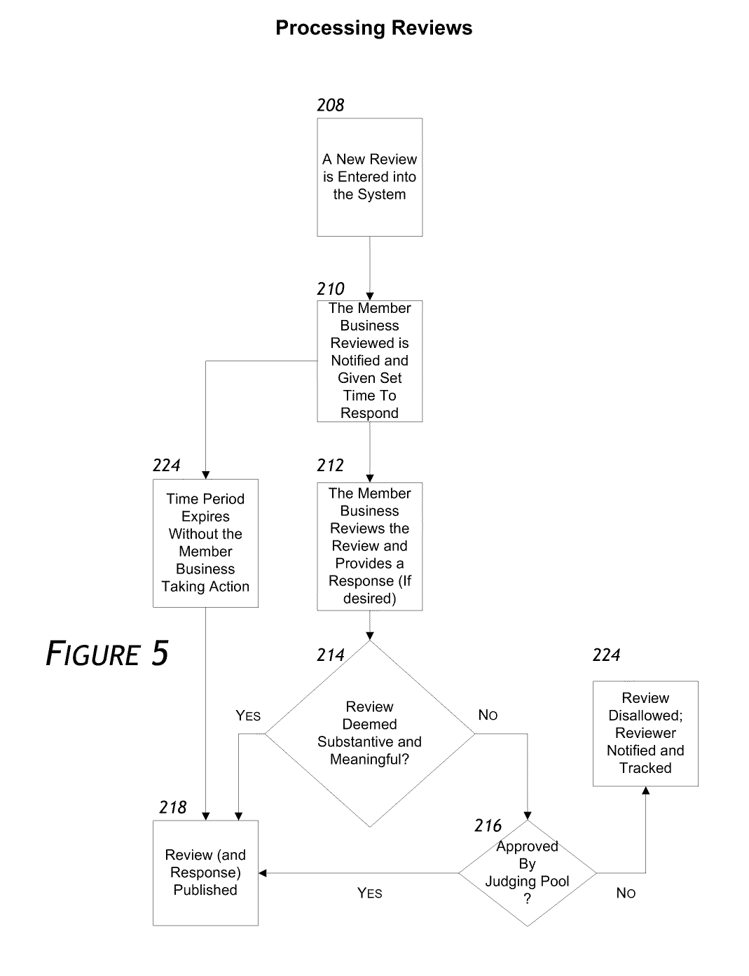

Finally, in one embodiment, the review, profile and marketing management system 100 comprises a review management module 134 that manages the interactive process 140 by which reviews entered by the reviewers may be responded to by the reviewed member business. The process is shown in greater details in FIG. 5.

Revenue Sharing Example—Sponsor

FIG. 3A is a flow chart showing the revenue sharing method in accordance with one embodiment. Blocks 102 and 104 are from FIG. 1. As shown, once a business signs up and becomes a member business at block 104, at block 146, in one embodiment revenue sharing is provided to the sponsor and to the appropriate persons and/or entities in the sponsor's genealogy. In one embodiment, the genealogies of reviewers are not limited to actual persons and may be entities such as organizations, companies, etc.

FIG. 3B shows an example of sharing through a sponsor's genealogy. As discussed above, in one embodiment, reviewers are classified into various levels. The example levels may include, in the order from highest to the lowest, “Publishers,” “Senior Editors,” “Editors,” “Certified Critics,” “Critics,” and “Reviewers.” In one embodiment, only reviewers at the critic level or above can sponsor a business. In one embodiment, a person may become a Critic by writing a at least a certain number of reviews, inviting and signing up at least a certain number of persons under his or her genealogy, and/or paying a fee. In other embodiments, any other number of reviewer levels may be used and the levels may have any suitable title, such as levels 1-5, levels A-D, etc.

In the example shown, the sponsor C1 is a Certified Critic. As a sponsor, C1 is eligible to receive 20% of the portion shared. For example, if the total spending amount is $100/month, the portion to be shared may be $30/month. Thus sponsor C1 would receive $6/month (20% of the $30). In one embodiment, the portion shared is a portion of the total amount spent by the business on marketing services, including but not limited to monthly marketing/membership dues, spending on exclusive promotions, keyword and/or banner marketing services.

In addition to the sponsor receiving a portion, the remaining amount to be shared is further divided in accordance with one or more distribution rules that can vary in different embodiments. Returning to FIG. 3B, reviewer B2 (a “Senior Editor” in this example), who is above sponsor C1 in the genealogy, may be eligible to receive 5% of the portion shared ($1.5 in the example above). Reviewer A (a “Publisher” in this example), who is above reviewer B2, may be eligible to receive 5% of the portion shared ($1.5 in the example above). If reviewer A has a parent in the genealogy, the parent may be eligible for sharing as well, and so on. In one embodiment, the percentage shared diminishes as the sharing travels up the genealogy. In one embodiment, there is no limit as to how many levels the sharing can travel up the genealogy. In one embodiment, the sharing is capped at a certain distance from the sponsor (e.g., 10 levels).

Additional Revenue Sharing/Distribution Example

FIG. 3D shows another example of sharing through a sponsor's genealogy. As discussed above, in one embodiment, reviewers are classified into various levels. The example levels may include, in the order from highest to the lowest, “Publishers,” “Senior Editors,” “Editors,” “Certified Critics,” and “Critics.” In other embodiments, any other number of reviewer levels may be used and the levels may have any suitable title, such as levels 1-5, levels A-D, etc.

In one embodiment, only reviewers at the Certified Critic level or above can sponsor a business and participate in revenue sharing. In one embodiment, a person may become a Certified Critic by paying a fee to purchase a support and membership enrollment package and by performing a number of activities to earn sufficient activity points. For example, in one embodiment, a person may need to earn 12 activity points to become a Certified Critic. The person can earn points by referring businesses to the system (1 point each). If a referred business purchases an initial marketing package, the person would earn 2 additional points. The person would earn 4 additional points if the same business pays the first monthly commission to maintain the purchased marketing package. In one embodiment, a person may become an Editor by sponsoring (signing up) at least a certain number of persons who go on to attain the Certified Critic level (e.g., three Certified Critics). In one embodiment, in order to move up to a different level, a Certified Critic will at least need to have accumulated more points and sponsored additional persons in his/her downline. Additional activity points may be required as follows in one embodiment: 16 points for Editor, 25 points for Senior Editor, and 35 points for Publisher. Additional downline sponsorship may be required as follows in one embodiment: 3 Certified Critics for Editor, 4 Editors for Senior Editor, 5 Senior Editors for Publisher. Thus, for example, in order to qualify as a Publisher, a person would need to have 5 qualified Senior Editors in 5 separate legs of his genealogy and have accumulated 35 activity points. In one embodiment, the point level must be achieved in each monthly period in order for the person to maintain the current level of qualification. In one embodiment, the requirements for each level are as follows:

Critic:

Enroll and purchase the Continue Marketing Support program

Certified Critic:

Produce twelve (12) activity points

Editor:

Be an active Certified Critic

Acquire sixteen (16) activity points

Have three (3) active legs with a Certified Critic at any level in each leg

Senior Editor:

Be an active Editor

Acquire twenty-five (25) activity points

Have a minimum of four (4) active legs with an Editor at any level in each leg

Active Team Sales volume of $6,000/month

Have 200 points across four (4) legs with no more than 40% of 200 (80) in a single leg

Publisher:

Be an active Senior Editor

Acquire thirty-five (35) activity points

Have a minimum of five (5) active legs with a Senior Editor at any level in each leg

Active Team Sales volume of $25,000/month

Have 1,000 points across five (5) legs with no more than 40% of 1,000 (400) in a single leg

In the example shown in FIG. 3D, C1 is an Editor with three Certified Critics under his genealogy (D1, D2, and D3). Under the distribution rules, C1 is eligible to receive a portion of monthly advertising revenue generated by those under his genealogy. In one embodiment, the monthly revenue sharing is provided according to the schedule as follows:

| Levels | Commission Share |
|---|---|
| 1 | 0.5% |
| 2 | 0.5% |
| 3 | 1% |
| 4 | 1% |
| 5 | 6% |
| 6 | 10% |
| 7 | 15% |

In the schedule, “Levels” indicate the number of levels down in the genealogy in which the referral was made. For example, since E1 is two levels from C1, C1 would earn 0.5% of the monthly revenue generated by E1's referred businesses. A1 would earn 1% of the monthly revenue generated by E1's referrals since A1 is four levels from C1. Publishers are eligible for additional generational commissions from 1 to 3%, depending on how many levels and other Publishers are in the downline.

In addition, in one embodiment, each person receives a share of the monthly revenue generated by his or her own referrals based on monthly revenue volume as follows:

| Volume | Commission Share |
|---|---|
| $0-$999 | 1% |
| $1,000-$1,999 | 2% |
| $2,000-$2,999 | 3% |
| $3,000-$3,999 | 4% |
| $4,000-$4,999 | 5% |
| $5,000-$5,999 | 6% |
| $6,000-$6,999 | 7% |
| $7,000-$7,999 | 8% |
| $8,000-$8,999 | 9% |
| $9,000+ | 10% |

### Bonuses

In one embodiment, bonuses may be awarded throughout the genealogy to encourage growth of the genealogy. For example, a Certified Critic who has earned 12 activity points within 30 days of his/her start date (date of joining the genealogy) qualifies for a $50 bonus. The person who sponsored the new Certified Critic may also receive a $50 bonus. In another embodiment, two other types of bonuses may be available: open line network development bonuses (Open Line NDBs) and generational network development bonuses (Generational NDBs). In one embodiment, an Open Line NDB is awarded to a person who has achieved an Editor level or above and who has someone in their downline that referred a new Certified Critic. Using the example of FIG. 3D, if A1 is an Editor and B1 is a Certified Critic, A1 would be eligible for an Open Line NDB if B1 referred C1 and C1 became a Certified Critic. In one embodiment, Generational NDB is awarded when a person downline attains the same level as the originating person. Taking the same example above, if B1 also became an Editor (the level achieved by A1), A1 would be eligible to receive a Generational NDB. In one embodiment, Open Line and Generational NDBs are awarded as follows:

| Editor | Senior Editor | Publisher |
|---|---|---|
| Open line = $50 | Open line = $75 | Open line = $50 |
| 1st generation = $20 | 1st generation = $40 | 1st generation = $20 |

Finally, in one embodiment, an editor achievement bonus is available when a person attains the level of an Editor within 30 days of joining by generating three Certified Critics in his downline. In one embodiment, the editor achievement bonus is set at $200. In other embodiments, the level requirements, activity point schedule, bonus amounts, and percentage amounts described above may vary.

Revenue Sharing Examples—Exclusive Promotions

Returning to FIG. 3A, at block 152, a member business may pay to offer exclusive promotions to reviewers in the system and thus generate marketing revenue that is shared through the sponsor's genealogy. In addition, as shown at block 154, the first set of reviewers to submit valid reviews may also be eligible to share a portion of what the member business spends to send the exclusive promotions. At block 156, the revenue is distributed to the first set of reviewers (and optionally to appropriate persons and/or entities in their genealogies).

FIG. 3C shows an example revenue sharing distribution for exclusive promotions. As shown in FIG. 3C, the portion of revenue to be shared 168 is divided into two portions 170 and 172. In one embodiment, portion 170 is provided to the sponsor's genealogy, for example, in accordance with the example shown in FIG. 3B. In one embodiment, portion 172 is provided to the set of qualified reviewers and optionally to appropriate persons and/or entities in their genealogies. As discussed above, in one embodiment a reviewer is qualified when he or she is among the first to take advantage of the exclusive promotions and write a qualified review. In this example, the genealogies of qualified reviewers A, B, C, D, and E are shown in FIG. 3C. Although five reviewers are shown, the number of qualified reviewers may be different in various embodiments and can vary by the exclusive promotions.

The example shows that portion 172 is divided among the first ten (or any other quantity in other embodiments) reviewers, with reviewers A-E and their genealogies each receiving $5 (the other five reviewers and genealogies who would receive the remaining portion are not shown). The amount is further divided in accordance with one or more distribution rules that can vary in different embodiments. For example, amount A1 may be 20% of the $5 (or the portion to be shared), amount A2 may be 5% of the $5 and amount A3 may be 5% of the $5.

FIG. 3E shows another example of revenue sharing for exclusive promotions. In the example of FIG. 3E, the portion of revenue to be shared 168 ($50) is divided among the first 10 reviewers who take advantage of the promotion and write qualified a review. As shown, each reviewer receives $5 and the amount is not shared with the rest of the genealogy. In one embodiment, in order to qualify for the revenue sharing, a reviewer must have achieved at least the level of a Certified Critic. As shown in FIG. 3E, in one embodiment a reviewer who has not reached the level of a Certified Critic (e.g., Reviewer A) may nonetheless receive some revenue sharing at a reduced rate ($1 shown). In one embodiment, the first person above A who has achieved at least a Certified Critic level shares a larger portion of the $5 (e.g., $3 as shown). The remaining portion of the $5 goes toward administrative cost.

Finally, the revenue sharing models/rules of FIG. 3B-3E are not mutually exclusive. Thus, as mentioned before, a person/entity may receive revenue from having referred a business that purchased a marketing package, written a qualified review based on an exclusive promotion, added additional persons downline, and a number of activities as described above. In addition, a person/entity who has a number of persons/entities downline in the genealogy can receive revenue from those downline persons/entities for one or more of the above described activities. Because of this cumulative nature of revenue sharing, it is to a person/entity's benefit to augment his/her/its genealogy.

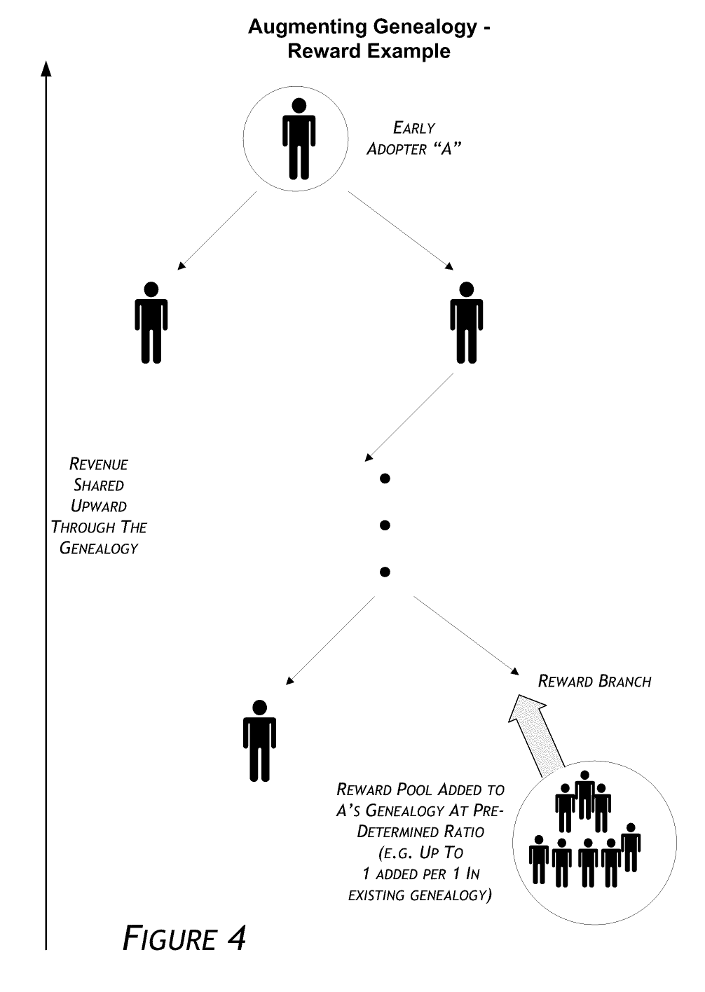

FIG. 4 shows an additional feature of the genealogies that assists in that effort in accordance with various embodiments. As mentioned before, a genealogy may be augmented by invitations. In addition to adding by invitations, in one embodiment, as shown in FIG. 4, a reward pool of new reviewers may be added to a genealogy on a rotational basis to encourage early sign-ups. For example, as shown, early adopter “A,” by virtue of signing up early and building his or her genealogy, is rewarded by the system assigning a certain number of persons to A′s existing genealogy. In one embodiment, the ratio of added persons to the existing persons in the genealogy is up to 1:1. In one embodiment, the system may obtain the reward pool of new reviewers from a number of means, e.g., through infomercials, internet marketing, and other direct response marketing. In one embodiment, the new reviewers are assigned to existing genealogies in the system on a rotational basis. Other embodiments may assign new reviewers to incentivize certain actions of existing reviewers (e.g. adding an additional new reviewer from the pool to an existing reviewer's genealogy if the existing reviewer brings in a certain number of reviewers).

Review Submission and Approval Process

FIG. 5 is a flowchart showing a review submission and approval process in one embodiment. In one embodiment, the process shown in FIG. 5 and/or variations thereof are performed by the review, profile and marketing management system 100 and/or the review management module 124. Depending on the embodiment, the method of FIG. 5 may include fewer or additional blocks and/or the blocks may be performed in a different order than is illustrated.

In one embodiment, the process begins at block 208, when a new review is received by the review, profile and marketing management system 100. In one embodiment, if the review is of a member business, at block 210 the member business is notified and given a set period to respond to the review (e.g., 1 day, 2 days, 3 days, 5 days, one week, or any other periods). The member business can choose to take no action at block 224 and let the review publish. In that case, the review may be published at the end of the set period at block 218. The member business may alternatively choose to review and/or respond to the review at block 212. If the business deems the review to be substantive and meaningful at block 214, the review proceeds to block 218 for publication. The business may also provide a response for publication, if desirable. In one embodiment, member businesses may receive training on providing proper responses to reviews.

Alternatively, the business may disapprove the review if it is deemed to be not substantive and meaningful at block 214. In one embodiment, the disapproved review is then forwarded to a judging pool at block 216. A judging pool may comprise of one or more persons who are dedicated to evaluate the reviews objectively. If the judging pool concurs, the review is disallowed and removed from the system. The reviewer may be notified and/or given a warning. In one embodiment, reviewers who repeatedly enter disapproved reviews will lose the ability to provide further reviews. The judging pool may alternatively approve the review and the review would proceed to block 218 for publication. As mentioned above, the reviews may be published as part of the POPP pages of the member businesses. In one embodiment, the sponsor of a business reviewed receives notification when a review for that business is published. In other embodiments, the reviews may be sent to websites that are licensing the review content. In one embodiment, the reviews may include both a description portion describing the reviewer's experience patronizing the member business and a numeric portion (e.g., a 5-star system) to quantify the experience. In one embodiment, member businesses may choose to be notified when a review with a low rating is entered so they may focus on unfavorable reviews and provide appropriate responses (e.g., 3 stars or less). In one embodiment, member businesses are notified of all reviews and are given the opportunity to respond and/or approve as described above.

Advertisement Management System

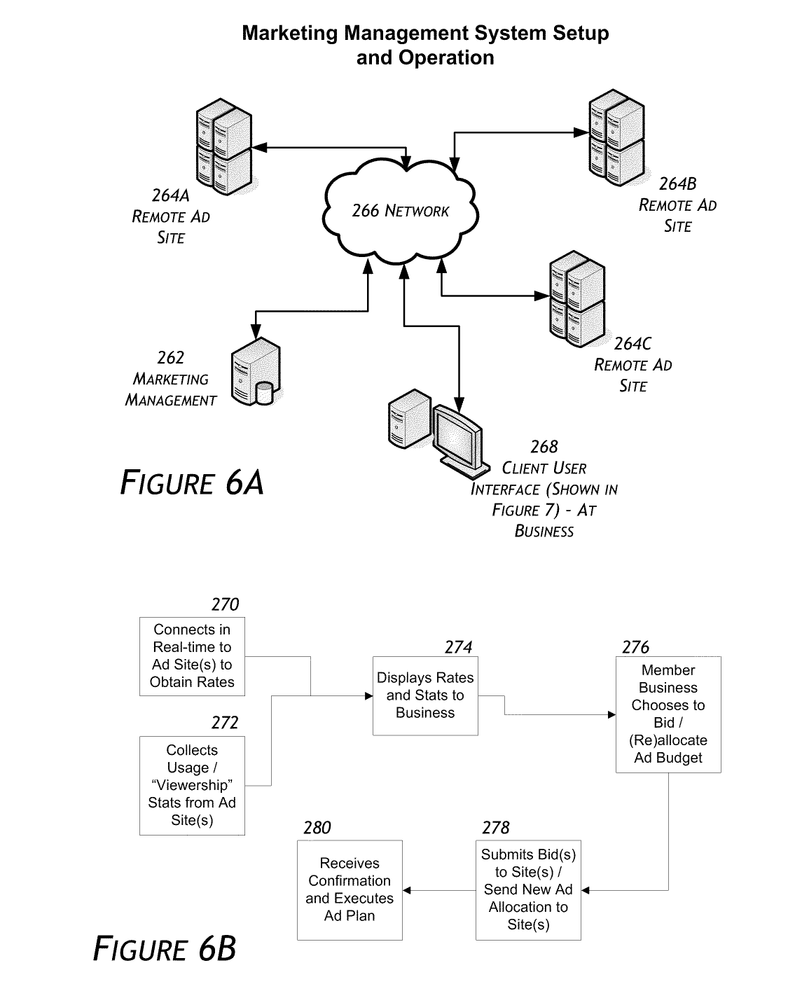

In certain embodiments, the review, profile and marketing management system 100 provides a marketing management module/system that enables member businesses to manage their marketing spending. FIG. 6A is a block diagram showing the marketing management system 262 as used in one embodiment. As shown, in one embodiment, the marketing management system 262 is connected via a network 266 to a number of remote ad sites 264A, 264B, and 264C. A member business with a client interface 268 may access the marketing management system 262 and manage marketing at the remote sites 264A, 264B, and 264C.

FIG. 6B is a flow chart showing a process performed by the marketing management system 262 in accordance with one embodiment. Depending on the embodiment, the method of FIG. 6B may include fewer or additional blocks and/or the blocks may be performed in a different order than is illustrated.

Beginning at block 270, the marketing management system 262 may connect in real-time or substantially real-time to the remote ad sites to obtain marketing rates. At block 272, the marketing management system 262 may collect usage or viewership statistics relating to any current ad campaign a member business may be conducting. At block 274, the marketing management system 262 may display the collected marketing rates and statistics to the member business through the user interface 268. At block 276, the member business may choose to submit bids for certain types of ads (e.g., keywords and banner ads) and/or re-allocate its current marketing budget. At block 278, the marketing management system 262 may submit the bids and/or the new allocations to one or more remote ad sites 264 on behalf of the member business. At block 280, the marketing management system 262 may receive confirmation from the remote ad sites and execute the new marketing plan.

Advertisement Management System—User Interface

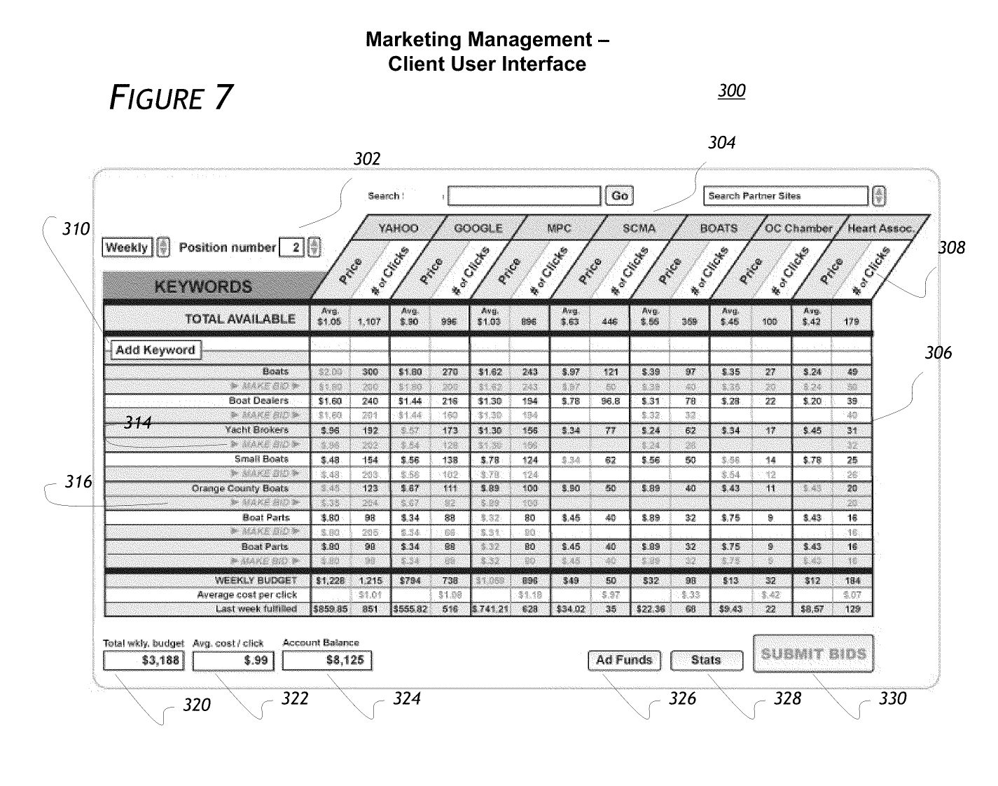

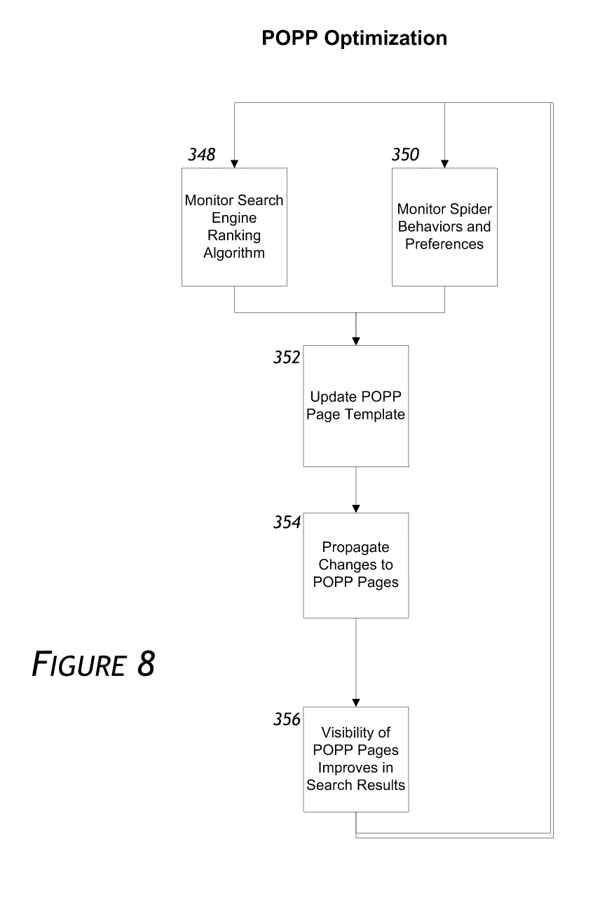

FIG. 7 is an example user interface for the marketing management system 262 in accordance with one embodiment. The user interface 300 as shown may be used to manage keyword advertisements at various remote sites listed in a top panel 304 (e.g., the remote ad sites shown in FIG. 6A). As shown, the top panel 304 also lists the individual sites, along with a rates and statistics heading 308 (price and number of clicks in the example shown). A list of keywords that are purchasable is displayed on a keyword panel 316 (left), and additional keywords may be added through a control 310. The grid in the middle reflects the current prices and the number of clicks for the listed keywords and for the individual remote sites. As prices and clicks are shown in the grid, the member business may be able to make an informed decision as to how best to allocate its marketing budget. The member business may be able to make a bid for any of the listed site/keyword combinations. For example, as shown in example 314, a member business may be able to bid on the keyword “Yacht Brokers” at the “Yahoo” site for the price of $0.96 per click. In one embodiment, a member business may select a number of such bids and submit all of them together by using a control 330, which may be a “submit bids” button as shown in FIG. 7.

The numbers shown in the grid can be adjusted by a control 302, which allows a member business to change the view by time period (e.g., weekly vs. daily vs. monthly) and by the position number indicating what position the member business would be listed in searches at the remote site for the indicated keyword. As shown, the amounts spent in the various keyword/site pairings are automatically tabulated with averages calculated per site. In one embodiment, at the bottom of the client user interface 300 are a number of text fields 320, 322, 324 that provide statistics related to the overall marketing budget. A member business may utilize a control 326 to manage funds for the marketing budget and a control 328 to access additional marketing statistics.

POPP Optimization

As referenced in the description of FIG. 1, POPP pages provide information about businesses and enable reviewers and the general public alike to find businesses listed/stored in the system. FIG. 8 is a flow chart showing a process of optimizing the POPP pages for increased exposure on the Internet and/or other data networking environments in accordance with one embodiment. Depending on the embodiment, the method of FIG. 8 may include fewer or additional blocks and/or the blocks may be performed in a different order than is illustrated.

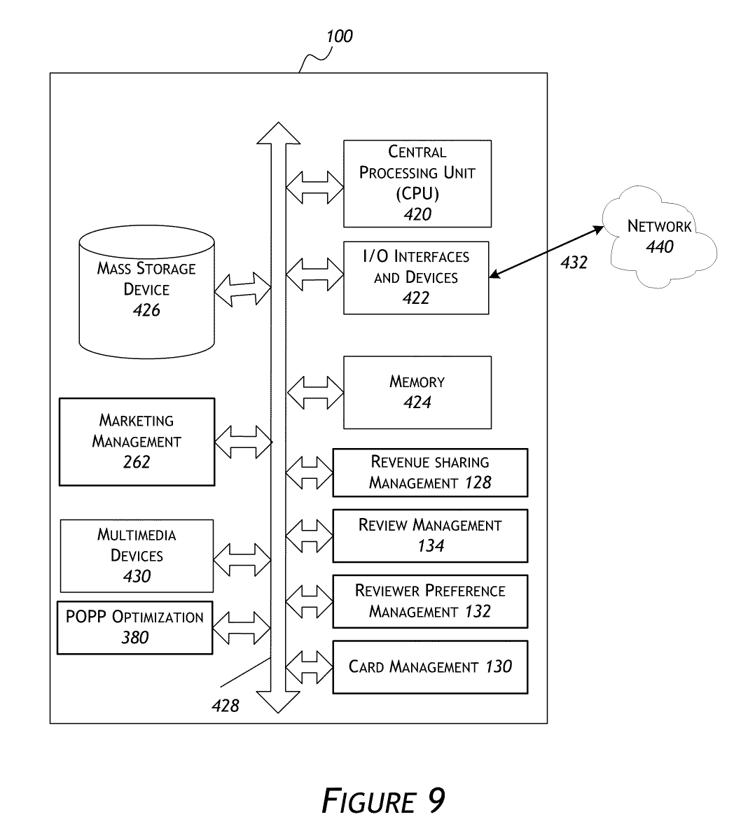

Starting at blocks 348 and 350, the process monitors both search engine algorithms and “spider” behaviors and/or preferences, respectively. A spider refers to an automated system that some search engines may employ to index content available on the Internet. At block 352, the process may modify the POPP page template based on the monitored results at blocks 348 and 350. In one embodiment, one or more POPP pages share a common template. At block 354, the process may thus propagate changes to the one or more POPP pages. As mentioned previously, POPP pages may be hosted on a directory site, and as such optimization changes to the template will likely cause such pages to be ranked higher in search engine results. In one embodiment, the process may utilize, for testing and other purposes, various templates with some POPP pages sharing one type of template and other POPP pages sharing another type of template. The process may monitor the performance of the various templates and selectively propagate changes to various POPP pages accordingly. At block 356, the visibility of the POPP pages improves as a result. The visibility of the POPP pages may also improve as a result of additional reviews being submitted for the individual businesses profiled in the POPP pages. The process may occur periodically and/or continually, and thus may begin anew at blocks 348 and 350. In other embodiments, the process undertakes actions at the various blocks concurrently. For example, the monitoring actions at blocks 348 and blocks 350 may take place while actions referenced in the other blocks are on-going. In one embodiment, the process shown in FIG. 8 and variations thereof are performed by a POPP optimization module 380 (shown in FIG. 9).

Targeting System Implementation

FIG. 9 is a block diagram illustrating the review, profile and marketing management system 100 in accordance with one embodiment. The review, profile and marketing management system 100 may include, for example, one or more servers and/or personal computers that are IBM/PC, Macintosh, or Linux/Unix compatible. In one embodiment, the review, profile and marketing management system 100 is a computerized system that comprises one or more computing devices, such as one or more servers, desktop computers, laptop computers, personal digital assistants, kiosks, or mobile devices, for example. In one embodiment, the review, profile and marketing management system 100 includes at least one central processing unit (“CPU”) 420, which may include one or more conventional microprocessors. The review, profile and marketing management system 100 may further include a memory 424, such as random access memory (“RAM”) for temporary storage of information and a read only memory (“ROM”) for permanent storage of information, and a mass storage device 426, such as a flash drive, a hard drive, a diskette, or an optical media storage device. Typically, the components and modules of the review, profile and marketing management system 100 and the various functions described herein may be embodied in code modules executed by the computing device or devices of the system. In different embodiments, a standard based bus system 428 could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of the review, profile and marketing management system 100 may be combined into fewer components and modules or further separated into additional components and modules.

The review, profile and marketing management system 100 is generally controlled and coordinated by operating system software, such as Windows Server, Linux Server, Windows 98, Windows NT, Windows 2000, Windows XP, Windows Vista, Windows 7, Unix, Linux, SunOS, Solaris, or other compatible server or desktop operating systems. In Macintosh systems, the operating system may be any available operating system, such as MAC OS X. In other embodiments, the review, profile and marketing management system 100 may be controlled by a proprietary operating system. Conventional operating systems control and schedule computer processes for execution, perform memory management, provide file system, networking, I/O services, and provide a user interface, such as a graphical user interface (“GUI”), among other things.

The review, profile and marketing management system 100 may include one or more commonly available input/output (I/O) devices and interfaces 422, such as a keyboard, mouse, touchpad, and printer. In one embodiment, the I/O devices and interfaces 422 include one or more display devices, such as a monitor, that allows the visual presentation of data to a user. More particularly, a display device provides for the presentation of GUIs, application software data, and multimedia presentations, for example. The review, profile and marketing management system 100 may also include one or more multimedia devices 430, such as speakers, video cards, graphics accelerators, and microphones, for example. In other embodiments, such as when the review, profile and marketing management system 100 comprises a network server, for example, the review, profile and marketing management system 100 may not include any of the above-noted man-machine I/O devices.

As shown in FIG. 9, the I/O devices and interfaces 422 may provide a communication interface to various external devices. In the embodiment of FIG. 9, the review, profile and marketing management system 100 is electronically coupled to a network 440, via a wired, wireless, or combination of wired and wireless, communication link 432. The network 440 may comprise one or more of a LAN, WAN, and/or the Internet, for example. The network 440 may facilitate communications among various computing devices and/or other electronic devices via wired or wireless communication links.

Data requests may be sent to the review, profile and marketing management system 100 over the network 440. Similarly, results may be returned over the network 440. In addition to the devices that are illustrated in FIG. 9, the review, profile and marketing management system 100 may communicate with other data sources or other computing devices. In addition, the data sources may include one or more internal and/or external data sources. In some embodiments, one or more of the databases, data repositories, or data sources may be implemented using a relational database, such as Sybase, Oracle, CodeBase, MySQL, and Microsoft® SQL Server as well as other types of databases such as, for example, a flat file database, an entity-relationship database, an object-oriented database, a record-based database, and/or a cloud-based database, such as that provided by Google or Amazon.

In the embodiment of FIG. 9, the review, profile and marketing management system 100 also includes a number of components/modules that may be executed by the CPU 420. As shown, they include the marketing management module 262, the revenue sharing management module 128, the review management module 134, the reviewer preference management module 132, the payment card management module 130, and/or the POPP optimization module 380. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Alternately, each of these modules may be implemented as separate devices or systems, such as computer servers. The modules may be combined into fewer modules and/or split into additional modules while performing the same functionalities.

In general, the word “module,” as used herein, refers to logic embodied in hardware or firmware, or to a collection of software instructions, possibly having entry and exit points, written in a programming language, such as, for example, Java, Lua, C, C++, or C#. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### Alternative Embodiments; Conclusion

Although this disclosure provides example embodiments related to businesses, embodiments of the invention are not so limited. For example, embodiments may be applied to the review of products, services, professional services (e.g., doctors, accountants), charities, governmental agencies, and/or housing (e.g. apartments, gated communities). In one or more embodiments, reviewer activities may be tracked by the review, profile and marketing management system 100. The tracked activities may be combined with preferences and/or demographic information entered by reviewers into reviewer profiles. The profiles may then be used to provide businesses access to certain reviewers who may be interested in the products and services offered by the businesses. For example, a golf pro shop may be able to reach reviewers whose profiles indicate that they are golf enthusiasts. In other embodiments, reviewers may be grouped by such profiles so they can be selected to participate in focus groups to evaluate certain products and/or services. In addition, the review, profile and marketing management system 100 may be configured under special arrangements with certain media companies to provide a platform for professional sales agents within those companies to sell the marketing packages and services described above.

Although this disclosure provides example embodiments related to Internet or online marketing, embodiments of the invention are not so limited to those environments. For example, embodiments of the invention can be implemented in any environment with addressable devices. For example, embodiments may be used in wireless devices such as cell phones and PDAs, cable television and satellite TV set top boxes, gaming consoles, and other portable devices such as music players and electronic book readers. Embodiments of the invention may be used in numerous environments, even those without “addressable” systems or those in “non-digital” media.

All of the methods and processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware. In addition, the components referred to herein may be implemented in hardware, software, firmware, or a combination thereof. The general purpose computers may, in some cases, include multiple distinct computers or computing devices (e.g., physical servers, workstations, storage arrays, etc,) that communicate and interoperate over a network to perform the described functions.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method, comprising:
maintaining data related to a plurality of persons, the data reflecting an arrangement of the plurality of persons in a hierarchy;
maintaining a business database storing records related to a plurality of businesses;
receiving a referral of one of the plurality of businesses provided by a first of the plurality of persons;
determining that the business that is the subject of the referral has purchased a marketing package subsequent to the referral; and
providing a first revenue credit to the first person and a plurality of second revenue credits to one or more persons in the hierarchy in accordance with one or more revenue credit rules, the first and second revenue credits being determined based at least in part on a cost of the marketing package purchased and a position of the first person in the hierarchy,
wherein the method is performed in its entirety by a computing system that comprises one or more computing devices.

2. The method of claim 1, further comprising:
receiving, by the computing system, a review of the business provided by a second of the plurality of persons in the hierarchy; and
providing, by the computer system, data suitable for display in an internet browser, the data comprising data related to the review and data related to identifying information of the business that is automatically retrieved from a record of the business in the business database.

3. The method of claim 2, further comprising:
transmitting, by the computing system, the review to the business so that the business can respond to the review.

4. The method of claim 2, wherein providing the data suitable for display further comprises obtaining, by the computer system, an approval from the business of the review.

5. The method of claim 2, wherein providing the data suitable for display further comprises optimizing, by the computer system, the data suitable for display to achieve a high ranking in a search engine.

6. The method of claim 1, wherein the review of the business is provided by the second person in response to a special offer from the business transmitted by the computer system to the second person, the special offer being transmitted in response to the business purchasing a special offer marketing package.

7. The method of claim 6, further comprising:
providing, by the computing system, a third revenue credit to the second person and a plurality of fourth revenue credits to one or more persons in the hierarchy in accordance with one or more of the revenue credit rules, the third and fourth revenue credits being determined at least in part on the cost of the special offer marketing package purchased and a position of the second person in the hierarchy.

8. The method of claim 1, wherein the revenue credit rules comprise rules for classifying persons in the hierarchy into a plurality of categories, the categories comprising a publisher category, a senior editor category, an editor category, a certified critic category, a critic category and a reviewer category.

9. The method of claim 8, wherein the revenue credit rules restrict the sharing of revenue credits to persons who are in a subset of the plurality of categories, each category of the subset of categories being assigned to a person when the person has paid a fee.

10. The method of claim 9, wherein the one or more persons receiving the second revenue credits have positions in the hierarchy equal or above the first person, the one or more persons having referred the first person directly or referred another person who has referred the first person.

11. The method of claim 9, wherein a portion of a fee is paid by a third person joining the hierarchy is distributed in accordance with the revenue credit rules to a fourth person who has referred the third person and to one or more persons who have positions in the hierarchy equal to or above the fourth person.

12. A marketing system comprising:
a computerized system comprising one or more computing devices, said computing devices configured to implement at least:
a business database that stores records related to a plurality of businesses;
a revenue sharing management process that manages data related to a plurality of persons, the data reflecting an arrangement of the plurality of persons in a hierarchy;
the computerized system configured to:
receive, from a first of the plurality of persons, a referral of one of the plurality of businesses;
receive a confirmation that the business in the referral has purchased a marketing package as a result of the referral; and
provide a first revenue credit to the first person and a plurality of second revenue credits to one or more persons in the hierarchy in the accordance with one or more revenue credit rules, the first and second revenue credits being determined at least in part on the cost of the marketing package purchased and a position of the first person in the hierarchy.

13. The marketing system of claim 12, wherein the computerized system is further to implement:
a review management process configured to receive a review of the business provided by a second of the plurality of persons in the hierarchy,
wherein the computerized system is configured to provide data suitable for display in an internet browser, the data comprising data related to the review and data related to identifying information of the business that is automatically retrieved from a record of the business in the business database.

14. The marketing system of claim 13, wherein the review management process is configured to:
transmit the review to the business so that the business can respond to the review.

15. The marketing system of claim 13, wherein the computerized system is further configured to obtain from the business an approval of the review prior to providing the data suitable for display.

16. The marketing system of claim 13, wherein the computerized system is further configured to optimize the data suitable for display to achieve a high ranking in a search engine.

17. The marketing system of claim 12, wherein the review of the business is provided by the second person in response to a special offer from the business transmitted by the system to the second person, the special offer being transmitted in response to the business purchasing a special offer marketing package.

18. The marketing system of claim 17, wherein the computerized system is further configured to:
provide a third revenue credit to the second person and a plurality of fourth revenue credits to one or more persons in the hierarchy in accordance with one or more of the revenue credit rules, the third and fourth revenue credits being determined at least in part on the cost of the special offer marketing package purchased and a position of the second person in the hierarchy.

19. The marketing system of claim 12, wherein the revenue credit rules comprise rules for classifying persons in the hierarchy into a plurality of categories, the categories comprising a publisher category, a senior editor category, an editor category, a certified critic category, a critic category and a reviewer category.

20. The marketing system of claim 19, wherein the revenue credit rules restrict the sharing of revenue credits to persons who are in a subset of the plurality of categories, each category of the subset of categories being assigned to a person when the person has paid a fee.

21. The marketing system of claim 20, wherein the one or more persons receiving the second revenue credits have positions in the hierarchy equal or above the first person, the one or more persons having referred the first person directly or referred another person who has referred the first person.

22. The marketing system of claim 20, wherein a portion of a fee is paid by a third person joining the hierarchy is distributed in accordance with the revenue credit rules to a fourth person who has referred the third person and to one or more persons who have positions in the hierarchy equal to or above the fourth person.

23. A computer storage comprising one or more storage devices, said computer storage comprising executable code that directs a computing system to perform a method that comprises:
maintaining data related to a plurality of persons, the data reflecting an arrangement of the plurality of persons in a hierarchy;
maintaining a business database storing records related to a plurality of businesses;
receiving a referral of one of the plurality of businesses provided by a first of the plurality of persons;
determining that the business that is the subject of the referral has purchased a marketing package subsequent to the referral; and
providing a first revenue credit to the first person and a plurality of second revenue credits to one or more persons in the hierarchy in the accordance with one or more revenue credit rules, the first and second revenue credits being determined based at least in part on a cost of the marketing package purchased and a position of the first person in the hierarchy.
